(19) United States
(12) Patent Application Publication
(10) Pub. No.: US 2002/0006482 A1
(43) Pub. Date: Jan. 17, 2002

(54) Multilayer blown film structure with polypropylene non-sealant layer and polyethylene sealant layer

(76) Inventors: Daniel J. Falla, Sarnia (CA); Tomas A. Fernandez, Horgen (CH); Jose V. Saavedra, Lake Jackson, TX (US); Li-Min Tau, Lake Jackson, TX (US); William R. Van Volkenburgh, Lake Jackson, TX (US)

Correspondence Address: THE DOW CHEMICAL COMPANY, INTELLECTUAL PROPERTY SECTION, 2301 N BRAZOSPORT BLVD, FREEPORT, TX, 77541-3257, US

(21) Appl. No.: 09/769,131

(22) Filed: Jan. 24, 2001

Related U.S. Application Data
(60) Provisional application No. 60/177,781, filed on Jan. 24, 2000.

(51) Int. Cl. B32B 1/02

(52) U.S. Cl. 428/35.2

(57) ABSTRACT

The present invention pertains to a multilayer blown film structure having a blended polypropylene layer and at least one polyethylene sealant layer. In particular, the invention relates to a multilayer blown film comprising a non-sealant layer made from a propylene-rich polypropylene polymer blended with at least one ethylene-rich ethylene interpolymer and a sealant layer made from at least one ethylene interpolymer, wherein the ethylene-rich ethylene interpolymer comprises ethylene interpolymerized with at least one other comonomer other than propylene. The novel multilayer film structure exhibits excellent interlayer adhesion (especially at the blended non-sealant/sealant interface when adjacent to one another) and toughness (e.g. excellent trouser tear) with acceptable optical properties and surprising sealing properties. The novel structure is preferably made using an air-quenched coextrusion fabrication technique and is particularly suited for use in making pouches for flowable materials, heavy-duty shipping sacks and overwrap films.

### CROSS-REFERENCE TO RELATED APPLICATIONS

This application claims the priority benefit of U.S. provisional application No. 60/177,781, filed Jan. 24, 2000; U.S. provisional application No. 60/257,513, filed Dec. 22, 2000; U.S. provisional application No. 60/232,977, filed Sep. 14, 2000; and U.S. provisional application No. 60/211,048, filed Jun. 12, 2000, the disclosures of all of which are incorporated herein by reference, in their entireties.

### FIELD OF INVENTION

The present invention pertains to a multilayer blown film structure having a blended polypropylene layer and at least one polyethylene sealant layer. In particular, the invention relates to a multilayer blown film comprising a non-sealant layer made from a propylene-rich polypropylene polymer blended with at least one ethylene-rich ethylene interpolymer and a sealant layer made from at least one ethylene interpolymer, wherein the ethylene-rich ethylene interpolymer comprises ethylene interpolymerized with at least one other comonomer other than propylene. The novel multilayer film structure exhibits excellent interlayer adhesion (especially at the blended non-sealant/sealant interface when adjacent to one another) and toughness (e.g. excellent trouser tear) with acceptable optical properties and surprising sealing properties. The novel structure is preferably made using an air-quenched coextrusion fabrication technique and is particularly suited for use in making pouches for flowable materials, heavy-duty shipping sacks and overwrap films.

### BACKGROUND OF THE INVENTION

In today's consumer packaging market, the trend is toward more environmentally friendly packages. Conventionally, many types of containers have been used to package flowable materials such as milk, juice, soup, nuts, ground meats, oil, and relishes. Conventional containers include glass bottles, paper cartons, high density polyethylene jugs, metal cans and PET bottles. Conventional containers consumed large amounts of natural resources to manufacture, require a significant landfill space, use substantial storage space and consume appreciable energy for contained-product temperature control (due to the heat transfer properties of the container). Conversely, packaging flowable materials in pouches made from thin polyethylene films reduces the above problems associated with conventional containers. Specifically, relative to conventional containers, a polyethylene pouch consumes less natural resources, requires less space in landfill, is recyclable and reusable, requires less storage space, uses less energy for storage (due to heat transfer properties of the thin film) and can be incinerated.

Most overwrap films used today are made from polyethylene and are used to package and protect soft goods such as toweling, toilet paper, napkins, straws, stir sticks, cutlery, hotel room glasses, and coffee condiment packages for retail trade. Aesthetics is an important property for overwrap film as the film must bear the advertisements of the distributor and allow the consumer to observe the packaged contents. Another important property of overwrap film is its crispness and its ability provide tamper evidence. Additionally, good stiffness is required to facilitate easy conversion through high speed packaging equipment.

Polypropylene resins have a number of useful properties that make them highly suitable for flowable material pouches, heavy-duty shipping sacks, overwrap films and packaging applications. But polypropylene resins generally exhibit low melt strength and as such (unlike polyethylene resins) polypropylene resins typically are not used to prepare air-quenched blown films, especially air-quenched blown films.

U.S. Pat. No. 5,206,075 (Hodgson, Jr.), the disclosure of which is incorporated herein by reference, discloses a laminar polyolefin film having a base layer comprising a blend of a polypropylene polymer and a very low density ethylene/alpha monoolefin copolymer and at least one heat sealable layer comprising a very low density copolymer of ethylene and a different alpha monoolefin. Hodgson discloses that the base layer may be extruded into film using a flat die or blown extruded into film using a tubular die, and the heat seal layer may be formed on the base layer by solvent deposition, lamination or coextrusion techniques. A preferred method is described as “coextrusion wherein a molten layer of the heat seal material is applied to the surface of an extruded cast film of the base layer.” Similarly, the examples reported by Hodgson are prepared by “coextrusion” on a compounding extruder and the heat seal layer is referred to as the “coating layer”. That is, there is no specific description of preparation of the film by a blown coextrusion technique wherein the base layer and the heat seal layer are simultaneously extruded from a multi-channel annular, circular or tubular die to form a tube that is blown-up or inflated to form a bubble. Also, while Hodgson's examples allegedly show improved sealing properties where the comparative sealing layer is different, Hodgson does not teach improved sealing properties where the comparative sealing layer is the same.

U.S. Pat. No. 4,643,928 (Kimura et al.), the disclosure of which is incorporated herein, discloses a coextruded multilayer tubular two-layer film comprising an outer layer which comprises a linear ethylene α-olefin copolymer and an inner layer made of a polypropylene-base resin or a resin composition comprising a polypropylene-base resin and an ethylene α-olefin copolymer. The film is preferably fabricated by a water-quenched blown film technique and in addition to using a single linear low density ethylene α-olefin copolymer, a mixture of copolymers having different densities and/or melt indexes can be used. But examples reported therein make it clear that the polypropylene inner layer is the sealant layer and the polyethylene outer layer is the non-sealant layer of the described film. Further, Kimura et al. indicate that various fabrication techniques can be use, including water- and air-cooling inflation, yet the air-cooling blown film (inflation) technique is described as deficient due to bubble stability problems at high speeds and the inability to achieve satisfactory optical properties.

U.S. Pat. No. 5,874,139 (Bosiers et al.), the disclosure of which is incorporated herein by reference, discloses a multilayer structure having a sealant layer and a polypropylene layer wherein the sealant layer comprises as a polymer mixture of (A) from 5 to 95 weight percent, based on the total weight of the polymer mixture, of at least one first ethylene polymer which is a homogeneously branched substantially linear ethylene polymer or a homogeneously branched linear ethylene polymer, and (B) from 5 to 95 weight percent, based on the total weight of the polymer mixture, of at least one second ethylene polymer which is a homogeneously branched ethylene polymer or a heterogeneously branched linear ethylene polymer wherein the second ethylene polymer is characterized as having a density in the range of 0.89 g/cc to 0.965 g/cc, wherein the polymer mixture is characterized as having a density of from 0.89 g/cc to 0.93 g/cc and an I₂ melt index in the range of from 1 g/10 minutes to 5 g/10 minutes and wherein the molecular weight of the at least one first polymer is higher than the molecular weight of the at least one second polymer. U.S. Pat. No. 5,874,139 also discloses that the blown film process technique is suitable for fabricating the multilayer structure. But the examples reported in U.S. Pat. No. 5,874,139 are all cast film structures and there is no specific description nor examples of polypropylene blended with any other polymer.

Dr. Wout Luyten, in “Polypropylene Blown Film for Packaging”, Specialty Plastic Films '99 World Congress, Zurich, Switzerland (December 13-15, 199), the disclosure of which is incorporated herein by reference, teaches that polypropylene resins made using Montell's proprietary Catalloy process and sold under the designations Adflex and Adsyl are useful for air-quenched blown film applications as blend components for polypropylene homopolymers and heterophasic copolymers as well as in pure form. Dr. Luyten describes Adflex resins as low melt flow rate soft PP materials and as ex-reactor blends of ethylene and propylene. and Adsyl resins as low melt flow rate terpolymers. Adflex is described as an adhesion promoter as well as imparting improved bubble stability and impact and tear resistance to PP films. Adsyl resins are described as having a non-fusion quality with PE, good shrinkage and excellent seal properties where a high sealability grade is specifically described as providing improved hot tack properties when used in coextruded sealing layers. Adsyl and Adflex are amorphous polypropylene resins that are characteristically rubbery, soft material.

JP 58140248, the disclosure of which is incorporated herein, discloses a co-extruded PP/LLDPE film structure that allegedly has enhanced heat sealing properties.

JP 60006457, the disclosure of which is incorporated herein, discloses a tubular polyethylene/polypropylene film with allegedly improved transparency.

WO 9837142, the disclosure of which is incorporated herein, discloses a heat sealable metallocene-catalyzed polyethylene/polypropylene film.

U.S. Pat. No. 4,297,411 (Weiner), the disclosure of which is incorporated herein, discloses a heat sealable multilayer film comprising a polypropylene substrate and ethylene/olefin copolymer blend surface layer. The polypropylene substrate can be polypropylene, polypropylene copolymer or a blend of polypropylene homopolymer or copolymer and up to 40 weight percent of a compatible polyolefin or polyolefin blend. The surface layer is a blend of a copolymer of ethylene and higher olefin having 4 or more carbon atoms and a different copolymer of an alpha olefin having 2 or more carbon atoms and higher olefin. Extrusion coating and coextrusion are described as suitable fabrication methods for producing the film. But here is no specific description of producing the film using a blown film technique.

U.S. Pat. No. 4,303,709 (Olson), the disclosure of which is incorporated herein, discloses a two-layer coextruded bag consisting of an outer layer of polypropylene and an inner (sealant) layer of polyethylene, preferably high density polyethylene (HDPE). The bag is made using conventional blown tubular film coextrusion techniques. But there is no specific description of the polypropylene layer being blended.

JP 57064550, the disclosure of which is incorporated herein, discloses a two-layer coextruded film with layer (A) made of polypropylene and layer (B) made of an ethylene/alpha-olefin copolymer.

U.S. Pat. No. 4,565,738 (Purdy), the disclosure of which is incorporated herein, discloses multilayer film comprising a propylene polymer base layer and a receptive layer is comprised of a blend of propylene-ethylene end block copolymer and an ethylene-monoalphaolefin random copolymer. Fabrication of the film is described to preferably consist of using a coextrusion bubble technique with a multi-channel annular die. But the propylene polymer base layer is not described as being blended with any other polymer.

WO 9744178, the disclosure of which is incorporated herein, discloses a coextruded blown film comprising at least one layer of a metallocene-catalyzed polyethylene and at least one layer of an impact grade polypropylene resin. The impact grade polypropylene is described as having about 8-15percent by weight ethylene. There is no specific description of blending the impact grade polypropylene with any other polymer.

Edward P. Moore, Jr., Polypropylene Handbook, Hanser, New York (1996), the disclosure of which is incorporated herein by reference, at page 5 teaches impact grade polypropylenes are heterophasic copolymers usually containing up to about 40 percent ethylene-propylene rubber (EPR) intimately dispersed in a polypropylene matrix, usually homopolymer polypropylene. At page 92, Hanser teaches impact grade polypropylenes are made by a two-step sequential polymerization wherein a propylene homopolymer (or a slightly modified copolymer) is synthesized in the first step and a mixture of ethylene and propylene is copolymerized with the same catalyst system in the second step.

WO 9837142, the disclosure of which is incorporated herein, discloses a heat sealable film comprising at least one layer of polyethylene (preferably a metallocene-catalyzed polyethylene) and a layer of polypropylene. The polyethylene and the polypropylene can be blended with ethylene polymers. There is description that the polyethylene layer can be multilayer, coextruded and fabricated by the tubular process. The polyethylene is used as the sealing layer. But all the examples reported therein involve adhesive or extrusion lamination and there is no specific description that the polyethylene layer and the polypropylene layer being simultaneously coextruded.

Overwrap films made using polymer blends consisting of metallocene-catalyzed LLDPE are described by R. Halle, Tappi Polymer, Laminations and Coating Conference, Volume 2, pp.901-911, Tappi Press, Atlanata, Ga. (1999), the disclosure of which is incorporated herein by reference.

Laminated overwrap films are described in Canadian Patent Nos. 944914 and 940439, the disclosures of which are incorporated herein by reference.

Several documents describe pouches for packaging flowable foods and nonfood items, including U.S. Pat. No. 4,503,102 (Mollison); U.S. Pat. No. 4,521,437 (Storms); U.S. Pat. No. 5,288,531 (Falla);U.S. Pat. No. 5,364,486, (Falla); U.S. Pat. No. 5,360,648 (Falla); U.S. Pat. No. 5,508,051 (Falla); U.S. Pat. No. 5,721,025 (Falla); U.S. Pat. No. 5,879,768 (Falla); U.S. Pat. No. 5,942,579 (Falla); WO 98/29249 (Breck); and WO 99/10430 (Climenhage). The disclosures of all of which are incorporated herein by reference.

While there is a wealth of teaching directed to film structures comprising a polyethylene layer and a polypropylene layer, there exists a need for a blown film multilayer structure that exploits the favorable characteristics of semi-crystalline polypropylene as an core or dimensional layer as well as the favorable characteristics of polyethylene resins as sealant layers. That is, there is a need for structures and polymer combinations that solve the low melt strength/poor bubble stability problems of polypropylene resins generally associated with air-quenched blown film fabrication while providing good interlayer adhesion, toughness properties and sealing properties. Obtaining improved blown film structures will give converters and packagers more package design flexibility and offer certain productivity enhancements.

### SUMMARY OF THE INVENTION

We have discovered an improved multilayer film structure having at least one polypropylene-rich layer and at least one polyethylene-rich layer. The broad aspect of the invention is a coextruded air-quenched multilayer blown film structure comprising (A) a non-sealant layer comprised of a propylene-rich polypropylene polymer blended with at least one ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure has a maximum hot tack strength of greater than 5.0 Newton/25 millimeter, (more preferably greater than or equal to 6.0 N/25 mm and most preferably greater than or equal to 7.0 N/25 mm up to 25.0 N/25 mm) when fabricated at 1.0 mil thickness and tested using a JB Instrument (formerly Topwave) Hot Tack Tester set at a 0.5 second dwell, 0.2 second delay time, 40 psi seal bar pressure and 250 mm/second peel rate.

Another aspect of the invention is a pouch made from a coextruded air-quenched multilayer blown film structure which in tubular form has transversely heat sealed ends, the multilayer film structure comprising (A) a non-sealant layer comprised of a propylene-rich polypropylene polymer blended with at least one first ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure has a maximum hot tack strength of greater than or equal to 5.0 Newton/25 millimeter, when fabricated at 1.0 mil total film thickness and measured using a JB Instrument Hot Tack Tester set at a 0.5 second dwell, 0.2 second delay time, 40 psi seal bar pressure and 250 mm/second peel rate.

Another aspect of the invention is an overwrap film made from a coextruded air-quenched multilayer blown film structure comprising (A) a non-sealant layer comprised of a propylene-rich polypropylene polymer blended with at least one first ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure has a maximum hot tack strength of greater than or equal to 5.0 Newton/25 millimeter, when fabricated at 1.0 mil total film thickness and measured using a JB Instrument Hot Tack Tester set at a 0.5 second dwell, 0.2 second delay time, 40 psi seal bar pressure and 250 mm/second peel rate.

Another aspect of the invention is a heavy-duty shipping sack made from a coextruded air-quenched multilayer blown film structure comprising (A) a non-sealant layer comprised of a propylene-rich polypropylene polymer blended with at least one first ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure has a maximum hot tack strength of greater than or equal to 5.0 Newton/25 millimeter, when fabricated at 1.0 mil total film thickness and measured using a JB Instrument Hot Tack Tester set at a 0.5 second dwell, 0.2 second delay time, 40 psi seal bar pressure and 250 mm/second peel rate.

The inventive film structure is characterized by surprisingly improved sealing properties. In particular, the inventive structure exhibits substantial better sealing properties than comparative structures comprised of a polyethylene core layer and the same sealant layer(s) as the inventive film structure. The sealing improvements include higher maximum hot tack strength and a broader heat seal window. These results are considered surprising and unexpected because one would not expect the non-sealant layer (that is the outer or core layer) to directly affect the sealing performance of the sealant layer.

### DETAILED DESCRIPTION OF THE INVENTION

The term “coextruded blown film” is used herein to mean at least two polymer melt streams (especially the polymer melt stream of the non-sealant layer and the polymer melt stream of the sealant layer) are simultaneously extruded through a multi-channel tubular, annular or circular die to form a tube which is blown-up, inflated and/or cooled with air (or a combination of gases) to form a film.

The term “compounded” is used herein to mean the blending or mixing of a polypropylene polymer and an ethylene polymer occurs outside of any reactor system. That is, the term pertains to ex-reactor blending and excludes in situ preparation (in-reactor blending) of a polypropylene/ethylene polymer composition. Compounding includes melt mixing, extrusion compounding and tumble blending prior to blown film extrusion. The term “blended” encompasses in situ (in-reactor) preparation as well as compounding. Preferably, the non-sealant polypropylene layer comprises a polypropylene resin compounded with at least one first ethylene interpolymer without propylene interpolymerized therein.

The term “propylene-rich” as used herein means the polypropylene polymer comprises greater than 50 weight percent propylene.

The term “ethylene-rich” as used herein means the ethylene interpolymer comprises greater than 50 weight percent ethylene.

The term “air-quenched blown film” is used herein to refer to fabrication of film using an annular die (also known as “circular die” or “tubular die”) to form a molten tube and then using air to blow-up (inflate) and cool the tube. The term is inclusive as to conventional hot blown simple bubble, double-bubble and trapped bubble techniques and is exclusive as to water-quenched and spray cooled blown film fabrication unless the latter also include air-quenching. The term also encompasses the use of inert gases; that is blow-up and/or cooling air may be combined with inert gases such as CO₂, nitrogen, argon and helium. Coextruded air-quenched blown films refers to simultaneous extrusion of at least to polymer melt stream from a multi-channel annular, circular or tubular die to form a tube that is blown-up, inflated and/or cooled with air (or a combination of gases) to form a film.

The term “ethylene polymer composition” is used herein to refer to an ethylene polymer or blend of an ethylene polymer and another polymer.

The term “ethylene polymer” is used herein to refer to a polymer that is manufactured with ethylene as monomer or comonomer.

The term “sealant layer” is used herein to refer to that film layer that is heat sealable and is actually heat sealed (usually to itself) in over-wrapping and in the construction of a bag, sack or pouch. For instance, in bag, sack or pouch making, the sealant layer forms the inside of the bag, sack or pouch. The term refers to the film's physical structure.

The term “non-sealant layer” is used herein to refer to that film layer that may be heat sealable but is not directly heat sealed. For instance, in bag, sack or pouch making, the non-sealant layer forms the outside of the bag, sack or pouch when a two-layer film structure is used or a core layer of the bag, sack or pouch is when a three-layer film structure is used.

The polypropylene layer of the present invention comprises at least one polypropylene polymer. The at least one polypropylene polymer can be a homopolymer, copolymer or terpolymer, including random and impact copolymer. Preferably, the at least one polypropylene polymer isotactic (that is not atactic or syndiotactic) such that it is crystalline or semi-crystalline with good barrier properties.

A crystalline polypropylene polymer is a polymer with at least about 90 mole percent of its repeating units derived from propylene, preferably at least about 97 percent, more preferably at least about 99 percent. The term “crystalline” is used herein to mean isotactic polypropylene having at least about 93 percent isotactic triads as measured by ¹³C NMR, preferably at least about 95 percent, more preferably at least about 96 percent. Syndiotactic polypropylene is suitable for use in the polypropylene layer.

The at least one polypropylene polymer can be homopolymer polypropylene or propylene polymerized with one or more other monomers addition polymerizable with propylene. The other monomers are preferably olefins, more preferably alpha olefins, most preferably ethylene or an olefin having a structure RCH═CH₂ where R is aliphatic or aromatic and has at least two and preferably less than about 18 carbon atoms. Hydrocarbon olefin monomers within the skill in the art, include hydrocarbons having one or more double bonds at least one of which is polymerizable with the alpha olefin monomer.

Suitable alpha olefins for polymerizing with propylene include ethylene, 1-butene, 1-pentene, 1-hexene, 1-octene, 1-nonene, 1-decene, 1-unidecene, 1-dodecene as well as 4-methyl-1-pentene, 4-methyl-1-hexene, 5-methyl-1-hexene, vinylcyclohexane, styrene. The preferred alpha olefins include 1-hexene, and 1-octene.

Optionally, but not in the most preferred embodiment of the present invention, the polypropylene polymer comprises monomers having at least two double bonds which are preferably dienes or trienes. Suitable diene and triene comonomers include 7-methyl-1,6-octadiene, 3,7-dimethyl-1,6-octadiene, 5,7-dimethyl-1,6-octadiene, 3,7,11-trimethyl-1,6,10-octatriene, 6-methyl-1,5-heptadiene, 1,3-butadiene, 1,6-heptadiene, 1,7-octadiene, 1,8-nonadiene, 1,9-decadiene, 1,10-undecadiene, norbornene, tetracyclododecene, or mixtures thereof, preferably butadiene, hexadienes, and octadienes, most preferably 1,4-hexadiene, 1,9-decadiene, 4-methyl-1,4-hexadiene, 5-methyl-1,4-hexadiene, dicyclopentadiene, and 5-ethylidene-2-norbornene.

Preferably, the polypropylene polymer is selected such that the inventive film has a 1 percent machine direction secant modulus of at least 70,000 psi, more preferably of at least 85,000 psi up to 200,000 psi. Accordingly, the polypropylene polymer is not rubbery (such as ethylene-propylene rubber) or elastomeric (such as typical impact copolymer grades). More preferably, the at least one polypropylene polymer does not contain ethylene or butene interpolymerized therein. Most preferably, the at least one polypropylene polymer is a crystalline polypropylene polymer, most especially a coupled crystalline polypropylene polymer as the term “coupled” is described hereinbelow.

The term “impact grade polypropylene” is used herein to refer to heterophasic polypropylene polymers containing up to about 40 percent ethylene-propylene rubber (EPR) intimately dispersed in a polypropylene matrix, especially a crystalline homopolymer polypropylene matrix.

The polypropylene layer is polypropylene-rich (that is contains greater than 50 weight percent of a propylene-rich polypropylene polymer) but preferably comprises from about 60 to about 98 weight percent of the at least one polypropylene polymer, more preferably from about 70 to about 98 weight percent; and preferably from about 2 to about 40 weight percent, more preferably from about 2 to about 30 weight percent of the ethylene-rich ethylene interpolymer.

Suitable polypropylenes are formed by means within the skill in the art, for example, using single site catalysts or Ziegler Natta catalysts. The propylene and optional alpha-olefin monomers are polymerized under conditions within the skill in the art, for instance as disclosed by Galli, et al., Angew. Macromol. Chem., Vol. 120,. 73 (1984), or by E. P. Moore, et al. in Polypropylene Handbook, Hanser Publishers, New York, 1996, particularly pages 11-98, the disclosures of which are incorporated herein by reference.

The polypropylene polymer used in the present invention is suitably of any molecular weight distribution (MWD). Polypropylene polymers of broad or narrow MWD are formed by means within the skill in the art. For film toughness, generally a narrower MWD is preferred (for example, a M_{w}/Mₙ ratio or polydispersity of less than or equal to 3). Polypropylene polymers having a narrow MWD can be advantageously provided by visbreaking or by manufacturing reactor grades (non-visbroken) using single-site catalysis or both.

Polypropylene polymers for use in the present invention preferably have a weight average molecular weight as measured by gel permeation chromatography (GPC) greater than about 100,000, preferably greater than about 115,000, more preferably greater than about 150,000, most preferably greater than about 250,000 to obtain desirably high mechanical strength in the final product.

Preferably, the polypropylene polymer has a melt flow rate (MFR) in the range of about 0.01 to about 30 grams/10 minutes, more preferably in range of about 0.1 to about 10 grams/10 minutes, as measured in accordance with ASTM D1238 at 230° C./2.16 kg. In particular, a high molecular weight, high melt strength polypropylene polymer is preferred, thus a MFR less than 1 g/10 minutes, measured in accordance with ASTM D1238 at 230° C./2.16 kg, is most preferred.

Suitable polypropylene polymers are made using methods and procedures well known in the art using various catalyst systems including traditional Ziegler-Natta catalyst systems as well as metallocene (constrained geometry) catalyst systems. Suitable commercial materials include Shell's KF 6100 homopolymer polypropylene; Solvay 's KS 4005 polypropylene copolymer; Solvay's KS 300 polypropylene terpolymer; and INSPIRE polypropylene resins supplied by The Dow Chemical Company.

The at least one polypropylene polymer can be reactor-grade, visbroken, branched or coupled to provide increased nucleation and crystallization rates. The term “coupled” is used herein to refer to polypropylene polymers which are rheology-modified such that they exhibit a change in the resistance of the molten polymer to flow during extrusion (for example, in the extruder immediately prior to the annular die). Whereas “visbroken” is in the direction of chain-scission, “coupled” is in the direction of crosslinking or networking. An example of coupling is where a couple agent (for example, an azide compound) is added to a relatively high melt flow rate polypropylene polymer such that after extrusion the resultant polypropylene polymer composition attains a substantially lower melt flow rate than the initial melt flow rate. Preferably, for coupled or branched polypropylene (which is the preferred polypropylene polymer used in the present invention) the ratio of subsequent MFR to initial MFR is less than or equal to 0.7:1, more preferably less than or equal to 0.2:1.

Suitable branched polypropylene for use in the present invention is commercially available for instance from Montell North America under the trade designations Profax PF-611 and PF-814. Alternatively, suitable branched or coupled polypropylene can be prepared by means within the skill in the art such as by peroxide or electron-beam treatment, for instance as disclosed by DeNicola et al. in U.S. Pat. No. 5,414,027 (the use of high energy (ionizing) radiation in a reduced oxygen atmosphere); EP 0 190 889 to Himont (electron beam irradiation of isotactic polypropylene at lower temperatures); U.S. Pat. No. 5,464,907 (Akzo Nobel NV); EP 0 754 711 Solvay (peroxide treatment); and U.S. patent application Ser. No. 09/133,576, filed Aug. 13,1998 (azide coupling agents); the disclosures of all of which are incorporated herein by reference.

The ethylene-rich ethylene interpolymer that is blended with the propylene-rich polypropylene polymer does not contain any propylene, as ethylene-propylene polymers tend to be highly elastomeric and substantially reduce the modulus of the modified polypropylene polymer. The ethylene polymer of the sealant layer may be the same or different from the ethylene-rich ethylene interpolymer that is blended with the propylene-rich polypropylene polymer to provide the non-sealant layer.

Suitable ethylene-rich ethylene interpolymers (and suitable ethylene polymers for the sealant layer) include, for example, high density polyethylene (HDPE), heterogeneously branched linear low density polyethylene (LLDPE), heterogeneously branched ultra low density polyethylene (ULDPE), homogeneously branched linear ethylene polymers, homogeneously branched substantially linear ethylene polymers (i.e. homogeneously branched long chain branched ethylene polymers), ethylene vinyl or vinylidene aromatic monomer interpolymers, ethylene/acrylic acid (EAA) interpolymers, ethylene/methacrylic acid (EMAA) interpolymers, ethylene/vinyl acetate (EVA) interpolymers and combinations thereof. The sealant layer can comprise a homopolymer polyethylene such as low density polyethylene (LDPE) made under high-pressure, free-radical polymerization conditions, providing the homopolymer is blended with a suitable ethylene-rich ethylene interpolymer.

Heterogeneously branched linear low density polyethylene (LLDPE) and a blend of a heterogeneously branched linear low density polyethylene (LLDPE) with a homogeneously branched ethylene interpolymer are most preferred for blending with the propylene-rich polypropylene polymer (i.e. the non-sealant layer). Conversely, homogeneously branched ethylene interpolymers and blends of a homogeneously branched ethylene interpolymer with a heterogeneously branched ethylene polymer are most preferred for the sealant layer (due to the improved sealing polymers as well as dramatically improved tear properties).

The high density polyethylene (HDPE), heterogeneously branched linear low density polyethylene (LLDPE), heterogeneously branched ultra low density polyethylene (ULDPE), homogeneously branched linear ethylene polymers, or homogeneously branched substantially linear ethylene polymer that is blended with the polypropylene layer can be an interpolymer of ethylene with at least one C₄-C₂₀ α-olefin. The term “interpolymer” used herein indicates the polymer can be a copolymer, a terpolymer or the like. Monomers usefully copolymerized with ethylene to make the interpolymer include the C₄-C₂₀ α-olefins especially 1-pentene, 1-hexene, 4-methyl-1-pentene, and 1-octene. Especially preferred comonomers include 1-pentene, 1-hexene and 1-octene. Copolymers of ethylene and a C₄-C₂₀ α-olefin are especially preferred.

Suitable ethylene polymers for use in the sealant layer and non-sealant layer preferably have an I₂ melt index less than or equal to 10 grams/10 minutes, preferably less than 5 g/10 minutes, more preferably less than or equal to 3 g/10 minutes, most preferably less than or equal to 2.5 g/10 minutes, especially in the range of from about 0.1 to about 2 g/10 minutes, measured in accordance with ASTM D1238, Condition 190° C./2.16 kg.

Commercial examples of suitable ethylene-rich ethylene interpolymers are sold under the designations ATTANE, AFFINITY, DOWLEX, ELITE by The Dow Chemical Company; and Exceed and Exact by Exxon Chemical Company.

The propylene-rich polypropylene polymer and the ethylene-rich ethylene interpolymer can be blended with other polymers as long as such other polymers do not disturb the unique features of the film, nor significantly reduce the modulus of the polypropylene layer.

The term “substantially linear” means that the polymer backbone is substituted with 0.01 long chain branches/1000 carbons to 3 long chain branches/1000 carbons, more preferably from 0.01 long chain branches/1000 carbons to I long chain branches/1000 carbons, and especially from 0.05 long chain branches/1000 carbons to 1 long chain branches/1000 carbons.

Long chain branching is defined herein as a branch having a chain length greater than that of any short chain branches which are a result of comonomer incorporation. The long chain branch can be as long as about the same length as the length of the polymer back-bone.

Long chain branching can be determined by using ¹³C nuclear magnetic resonance (NMR) spectroscopy and is quantified using the method of Randall (Rev. Macromol. Chem. Phvs., C29 (2&3), p. 275-287), the disclosure of which is incorporated herein by reference.

Substantially linear ethylene polymers are characterized as having:

a) a melt flow ratio, I₁₀/I₂, 5.63,

b) a molecular weight distribution, M_{w}/Mₙ, defined by the equation:

M_{w}/Mₙ(I₀/I₂)−4.63, and

c) a critical shear stress at onset of gross melt fracture greater than 4×10⁶ dynes/cm² or a critical shear rate at onset of surface melt fracture at least 50 percent greater than the critical shear rate at the onset of surface melt fracture of either a homogeneously or heterogeneously branched linear ethylene polymer having about the same I₂ and M_{w}/Mₙ or both.

Also substantially linear ethylene polymers are manufactured using constrained geometry catalyst systems. Exemplary constrained geometry catalysts for use in polymerizing the homogeneously branched substantially linear ethylene polymers preferentially include those constrained geometry catalysts as disclosed in U.S. application Ser. No. 545,403, filed Jul. 3,1990; Ser. No. 758,654, now U.S. Pat. No. 5,132,380; Ser. No. 758,660, now abandoned, filed Sep. 12, 1991; and Ser. No. 720,041, now abandoned, filed Jun. 24,1991, and in U.S. Pat. No. 5,272,236 and U.S. Pat. No. 5,278,272, the disclosures of all of which are incorporated herein by reference.

In contrast to substantially linear ethylene polymers, linear ethylene polymers lack long chain branching, i.e., they have less than 0.01 long chain branches/1000 carbons. The term “linear ethylene polymers” thus does not refer to high pressure branched polyethylene, ethylene/vinyl acetate copolymers, or ethylene/vinyl alcohol copolymers which are known to those skilled in the art to have numerous long chain branches.

Linear ethylene polymers include, for example, the traditional heterogeneously branched linear low density polyethylene polymers or linear high density polyethylene polymers made using Ziegler polymerization processes (e.g., U.S. Pat. No. 4,076,698 (Anderson et al.)) the disclosure of which is incorporated herein by reference), or homogeneous linear polymers (e.g., U.S. Pat. No. 3,645,992 (Elston) the disclosure of which is incorporated herein by reference).

Both the homogeneously branched linear and the substantially linear ethylene polymers have homogeneous branching distributions. The term “homogeneously branching distribution” means that the comonomer is randomly distributed within a given molecule and that substantially all of the copolymer molecules have the same ethylene/comonomer ratio. The homogeneous ethylene/α-olefin polymers used in this invention essentially lack a measurable “high density” fraction as measured by the TREF technique (i.e., the homogeneous branched ethylene/α-olefin polymers are characterized as typically having less than 15 weight percent, preferably less than 10 weight percent, and more preferably less than 5 weight percent of a polymer fraction with a degree of branching less than or equal to 2 methyls/1000 carbons).

The homogeneity of the branching distribution can be measured variously, including measuring the SCBDI (Short Chain Branch Distribution Index) or CDBI (Composition Distribution Branch Index). SCBDI or CDBI is defined as the weight percent of the polymer molecules having a comonomer content within 50 percent of the median total molar comonomer content. The CDBI of a polymer is readily calculated from data obtained from techniques known in the art, such as, for example, temperature rising elusion fractionation (abbreviated herein as “TREF) as described, for example, in Wild et al, Journal of Polymer Science, Poly. Phys. Ed., Vol. 20, p. 441 (1982), U.S. Pat. No. 5,008,204 (Stehling), the disclosure of which is incorporated herein by reference. The technique for calculating CDBI is described in U.S. Pat. No. 5,322,728 (Davey et al.) and in U.S. Pat. No. 5,246,783 (Spenadel et al.), both disclosures of which are incorporated herein by reference. The SCBDI or CDBI for homogeneously branched linear and substantially linear ethylene polymers is typically greater than 30 percent, and is preferably greater than 50 percent, more preferably greater than 60 percent, even more preferably greater than 70 percent, and most preferably greater than 90 percent.

The homogeneous branched ethylene polymers useful in the present invention will preferably have a single melting peak, as measured using differential scanning calorimetry (DSC), in contrast to heterogeneously branched linear ethylene polymers, which have 2 or more melting peaks, due to the heterogeneously branched polymer's broad branching distribution.

Homogeneously branched linear ethylene interpolymers are a known class of polymers which have a linear polymer backbone, no long chain branching and a narrow molecular weight distribution. Such polymers are interpolymers of ethylene and at least one α-olefin comonomer of from 3 to 20 carbon atoms, and are preferably copolymers of ethylene with a C₄-C₂₀ α-olefin, and are most preferably copolymers of ethylene with 1-butene, 1-hexene, 4-methyl-1-pentene or 1-octene. This class of polymers is disclosed for example, by Elston in U.S. Pat. No. 3,645,992 and subsequent processes to produce such polymers using metallocene catalysts have been developed, as shown, for example, in EP 0 129 368, EP 0 260 999, U.S. Pat. No. 4,701,432; U.S. Pat. No. 4,937,301; U.S. Pat. No. 4,935,397; U.S. Pat. No. 5,055,438; and WO 90/07526, and others. The polymers can be made by conventional polymerization processes (e.g., gas phase, slurry, solution, and high pressure).

The molecular weight distributions of are determined by gel permeation chromatography (GPC) on a Waters 150 C high temperature chromatographic unit equipped with a differential refractometer and three columns of mixed porosity. The columns are supplied by Polymer Laboratories and are commonly packed with pore sizes of 10³, 10⁴, 10⁵ and 10⁶ Å. The solvent is 1,2,4-trichlorobenzene, from which about 0.3 percent by weight solutions of the samples are prepared for injection. The flow rate is about 1.0 milliliters/minute, the unit operating temperature is about 140° C., and the injection size is about 100 microliters.

The molecular weight determination with respect to the polymer backbone is deduced by using narrow molecular weight distribution polystyrene standards (from Polymer Laboratories) in conjunction with their elution volumes. The equivalent polyethylene molecular weights are determined by using appropriate Mark-Houwink coefficients for polyethylene and polystyrene (as described by Williams and Ward in Journal of Polymer Science Polymer Letters, Vol. 6, p. 621, 1968) to derive the following equation:

M_{polyethylene}=a*(M_{polystyrene})^{b}.

In this equation, a=0.4316 and b=1.0. Weight average molecular weight, Mw, is calculated in the usual manner according to the following formula: Mⱼ=(wᵢ(Mᵢ^{j}))^{j}; where wⱼ is the weight fraction of the molecules with molecular weight Mᵢ eluting from the GPC column in fraction i and j=1 when calculating _{Mw} and j=−1 when calculating Mₙ. Preferred ethylene-rich ethylene interpolymers have a M_{w}/Mₙ less than or equal to 3.3, preferably less than or equal to 3, and especially in the range of from about 2.5 to about 1.5.

As indicated above, substantially random ethylene/vinyl aromatic interpolymers are useful as the ethylene-rich ethylene interpolymer. Representative of substantially random ethylene/vinyl aromatic interpolymers are substantially random ethylene/styrene interpolymers preferably containing at least 20, more preferably equal to or greater than 30, and most preferably equal to or greater than 50 weight percent interpolymerized styrene monomer.

A substantially random interpolymer comprises in polymerized form i) one or more α-olefin monomers and ii) one or more vinyl or vinylidene aromatic monomers and/or one or more sterically hindered aliphatic or cycloaliphatic vinyl or vinylidene monomers, and optionally iii) other polymerizable ethylenically unsaturated monomer(s).

The term “substantially random” in the substantially random interpolymer resulting from polymerizing i) one or more α-olefin monomers and ii) one or more vinyl or vinylidene aromatic monomers and/or one or more sterically hindered aliphatic or cycloaliphatic vinyl or vinylidene monomers, and optionally iii) other polymerizable ethylenically unsaturated monomer(s) as used herein generally means that the distribution of the monomers of said interpolymer can be described by the Bernoulli statistical model or by a first or second order Markovian statistical model, as described by J. C. Randall in Polymer Sequence Determination, Carbon-13 NMR Method, Academic Press New York, 1977, pp. 71-78. Preferably, the substantially random interpolymer resulting from polymerizing one or more α-olefin monomers and one or more vinyl or vinylidene aromatic monomers, and optionally other polymerizable ethylenically unsaturated monomer(s), does not contain more than 15 percent of the total amount of vinyl or vinylidene aromatic monomer in blocks of vinyl or vinylidene aromatic monomer of more than 3 units. More preferably, the interpolymer is not characterized by a high degree of either isotacticity or syndiotacticity. This means that in the carbon-13 NMR spectrum of the substantially random interpolymer, the peak areas corresponding to the main chain methylene and methine carbons representing either meso diad sequences or racemic diad sequences should not exceed 75 percent of the total peak area of the main chain methylene and methine carbons.

By the subsequently used term “substantially random interpolymer” it is meant a substantially random interpolymer produced from the above-mentioned monomers.

Suitable α-olefin monomers which are useful for preparing the substantially random interpolymer include, for example, α-olefin monomers containing from 2 to 20, preferably from 2 to 12, more preferably from 2 to 8 carbon atoms. Preferred such monomers include ethylene, propylene, butene-1,4-methyl-1-pentene, hexene-1 and octene-1. Most preferred are ethylene or a combination of ethylene with C₃-C₈ α-olefins. These α-olefins do not contain an aromatic moiety.

Suitable vinyl or vinylidene aromatic monomers which can be employed to prepare the substantially random interpolymer include, for example, those represented by the following formula I

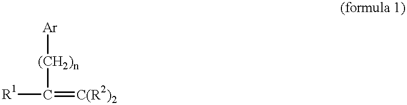

wherein R¹ is selected from the group of radicals consisting of hydrogen and alkyl radicals containing from 1 to 4 carbon atoms, preferably hydrogen or methyl; each R² is independently selected from the group of radicals consisting of hydrogen and alkyl radicals containing from 1 to 4 carbon atoms, preferably hydrogen or methyl; Ar is a phenyl group or a phenyl group substituted with from 1 to 5 substituents; selected from the group consisting of halo, C₁-C₄-alkyl, and C₁-C₄-haloalkyl; and n has a value from zero to 4, preferably from zero to 2, most preferably zero. Particularly suitable such monomers include styrene and lower alkyl- or halogen-substituted derivatives thereof. Exemplary monovinyl or monovinylidene aromatic monomers include styrene, vinyl toluene, α-methylstyrene, t-butyl styrene or chlorostyrene, including all isomers of these compounds. Preferred monomers include styrene, α-methyl styrene, the lower alkyl-(C₁-C₄) or phenyl-ring substituted derivatives of styrene, such as for example, ortho-, meta-, and para-methylstyrene, the ring halogenated styrenes, para-vinyl toluene or mixtures thereof. A more preferred aromatic monovinyl monomer is styrene.

By the term “sterically hindered aliphatic or cycloaliphatic vinyl or vinylidene monomers”, it is meant addition polymerizable vinyl or vinylidene monomers corresponding to the formula:

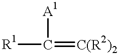

wherein A¹ is a sterically bulky, aliphatic or cycloaliphatic substituent of up to 20 carbons, R¹ is selected from the group of radicals consisting of hydrogen and alkyl radicals containing from 1 to 4 carbon atoms, preferably hydrogen or methyl; each R² is independently selected from the group of radicals consisting of hydrogen and alkyl radicals containing from 1 to 4 carbon atoms, preferably hydrogen or methyl; or alternatively R¹ and A¹ together form a ring system.

By the term “sterically bulky” is meant that the monomer bearing this substituent is normally incapable of addition polymerization by standard Ziegler-Natta polymerization catalysts at a rate comparable with ethylene polymerizations.

α-Olefin monomers containing from 2 to about 20 carbon atoms and having a linear aliphatic structure such as propylene, butene-1, hexene-1 and octene-1 are not considered as sterically hindered aliphatic monomers. Preferred sterically hindered aliphatic or cycloaliphatic vinyl or vinylidene compounds are monomers in which one of the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl or norbornyl. Most preferred sterically hindered aliphatic or cycloaliphatic vinyl or vinylidene compounds are the various isomeric vinyl-ring substituted derivatives of cyclohexene and substituted cyclohexenes, and 5-ethylidene-2-norbornene. Especially suitable are 1-, 3-, and 4-vinylcyclohexene.

The substantially random interpolymers usually contain from about 0.5 to about 65, preferably from about 1 to about 55, more preferably from about 2 to about 50 mole percent of at least one vinyl or vinylidene aromatic monomer and/or sterically hindered aliphatic or cycloaliphatic vinyl or vinylidene monomer and from about 35 to about 99.5, preferably from about 45 to about 99, more preferably from about 50 to about 98 mole percent of at least one aliphatic α-olefin having from about 2 to about 20 carbon atoms.

Other optional polymerizable ethylenically unsaturated monomer(s) include strained ring olefins such as norbornene and C₁-C₁₀-alkyl or C₆-C₁₀-aryl substituted norbornenes, with an exemplary substantially random interpolymer being ethylene/styrene/norbornene.

The most preferred substantially random interpolymers are interpolymers of ethylene and styrene and interpolymers of ethylene, styrene and at least one α-olefin containing from 3 to 8 carbon atoms.

The number average molecular weight (Mₙ) of the substantially random interpolymers is usually greater than 5,000, preferably from about 20,000 to about 1,000,000, more preferably from about 50,000 to about 500,000. The glass transition temperature (T_{g}) of the substantially random interpolymers is preferably from about −40° C. to about +35°C., preferably from about 0° C. to about +30° C., most preferably from about +10° C. to about +25° C., measured according to differential mechanical scanning (DMS).

The substantially random interpolymers may be modified by typical grafting, hydrogenation, functionalizing, or other reactions well known to those skilled in the art. The polymers may be readily sulfonated or chlorinated to provide functionalized derivatives according to established techniques. The substantially random interpolymers may also be modified by various chain extending or crosslinking processes including, but not limited to peroxide-, silane-, sulfur-, radiation-, or azide-based cure systems. A full description of the various crosslinking technologies is described in copending U.S. patent application Ser. Nos. 08/921,641 and 08/921,642, both filed on Aug. 27,1997, the entire contents of both of which are herein incorporated by reference.

Dual cure systems, which use a combination of heat, moisture cure, and radiation steps, may also be effectively employed. Dual cure systems are disclosed and claimed in U.S. patent application Ser. No. 536,022, filed on Sep. 29, 1995, in the names of K. L. Walton and S. V. Karande, incorporated herein by reference. For instance, it may be desirable to employ peroxide crosslinking agents in conjunction with silane crosslinking agents, peroxide crosslinking agents in conjunction with radiation, sulfur-containing crosslinking agents in conjunction with silane crosslinking agents, etc.

The substantially random interpolymers may also be modified by various crosslinking processes including, but not limited to the incorporation of a diene component as a termonomer in its preparation and subsequent crosslinking by the aforementioned methods and further methods including vulcanization via the vinyl group using sulfur for example as the cross linking agent.

One suitable method for manufacturing substantially random ethylene/vinyl aromatic interpolymers includes polymerizing a mixture of polymerizable monomers in the presence of one or more metallocene or constrained geometry catalysts in combination with various cocatalysts, as described in EP-A-0,416,815 by James C. Stevens et al. and U.S. Pat. No. 5,703,187 by Francis J. Timmers, both of which are incorporated herein by reference in their entirety. Preferred operating conditions for such polymerization reactions include pressures from atmospheric up to 3000 atmospheres and temperatures from −300° C. to 200° C. Polymerizations and unreacted monomer removal at temperatures above the auto-polymerization temperature of the respective monomers may result in formation of some amounts of homopolymer polymerization products resulting from free radical polymerization.

Examples of suitable catalysts and methods for preparing the substantially random interpolymers are disclosed in U.S. application Ser. No. 702,475, filed May 20, 1991 (EP-A-514,828); as well as U.S. Pat. Nos. 5,055,438; 5,057,475; 5,096,867; 5,064,802; 5,132,380; 5,189,192; 5,321,106; 5,347,024; 5,350,723; 5,374,696; 5,399,635; 5,470,993; 5,703,187; and 5,721,185, all of which patents and applications are incorporated herein by reference.

The substantially random ethylene/vinyl aromatic interpolymers can also be prepared by the methods described in JP 07/278230 (the disclosure of which is incorporated herein by reference) employing compounds shown by the general formula

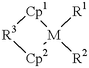

Where Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf, most preferably Zr; and R³ is an alkylene group or silanediyl group used to crosslink Cp¹ and Cp².

The substantially random ethylene/ vinyl aromatic interpolymers can also be prepared by the methods described by John G. Bradfute et al. (W. R. Grace & Co.) in WO 95/32095; by R. B. Pannell (Exxon Chemical Patents, inc.) in WO 94/00500; and in Plastics Technology p. 25 (September 1992), all of which are incorporated herein by reference in their entirety.

Also suitable are the substantially random interpolymers which comprise at least one α-olefin/vinyl aromatic/vinyl aromatic/α-olefin tetrad disclosed in U.S. application Ser. No. 08/708,869, filed Sep. 4,1996, and WO 98/09999, both by Francis J. Timmers et al. These interpolymers contain additional signals in their carbon-13 NMR spectra with intensities greater than three times the peak to peak noise. These signals appear in the chemical shift range 43.70-44.25 ppm and 38.0-38.5 ppm. Specifically, major peaks are observed at 44.1, 43.9, and 38.2 ppm. A proton test NMR experiment indicates that the signals in the chemical shift region 43.70-44.25 ppm are methine carbons and the signals in the region 38.0-38.5 ppm are methylene carbons.

It is believed that these new signals are due to sequences involving two head-to-tail vinyl aromatic monomer insertions preceded and followed by at least one α-olefin insertion, e.g. an ethylene/styrene/styrene/ethylene tetrad wherein the styrene monomer insertions of said tetrads occur exclusively in a 1,2 (head to tail) manner. It is understood by one skilled in the art that for such tetrads involving a vinyl aromatic monomer other than styrene and an α-olefin other than ethylene that the ethylene/vinyl aromatic monomer/vinyl aromatic monomer/ethylene tetrad will give rise to similar carbon-13 NMR peaks but with slightly different chemical shifts.

These interpolymers can be prepared by conducting the polymerization at temperatures of from about −30° C. to about 250° C. in the presence of such catalysts as those represented by the formula:

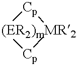

wherein each Cp is independently, each occurrence, a substituted cyclopentadienyl group -bound to M; E is C or Si; M is a group IV metal, preferably Zr or Hf, most preferably Zr; each R is independently, each occurrence, H, hydrocarbyl, silahydrocarbyl, or hydrocarbylsilyl, containing up to 30, preferably from about 1 to about 20, more preferably from about 1 to about 10 carbon or silicon atoms; each R′ is independently, each occurrence, H, halo, hydrocarbyl, hyrocarbyloxy, silahydrocarbyl, hydrocarbylsilyl containing up to 30, preferably from about 1 to about 20, more preferably from about 1 to about 10 carbon or silicon atoms or two R′ groups together can be a C₁-C₁₀ hydrocarbyl substituted 1,3-butadiene; M is 1 or 2; and optionally, but preferably in the presence of an activating cocatalyst.

Particularly, suitable substituted cyclopentadienyl groups include those illustrated by the formula:

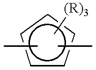

wherein each R is independently, each occurrence, H, hydrocarbyl, silahydrocarbyl, or hydrocarbylsilyl, containing up to 30, preferably from about 1 to about 20, more preferably from about 1 to about 10 carbon or silicon atoms or two R groups together form a divalent derivative of such group. Preferably, R independently each occurrence is (including where appropriate all isomers) hydrogen, methyl, ethyl, propyl, butyl, pentyl, hexyl, benzyl, phenyl or silyl or (where appropriate) two such R groups are linked together forming a fused ring system such as indenyl, fluorenyl, tetrahydroindenyl, tetrahydrofluorenyl, or octahydrofluorenyl.

Particularly preferred catalysts include, for example, racemic-(dimethylsilanediyl)-bis-(2-methyl-4-phenylindenyl) zirconium dichloride, racemic-(dimethylsilanediyl)-bis-(2-methyl-4-phenylindenyl) zirconium 1,4diphenyl-1,3-butadiene, racemic-(dimethylsilanediyl)-bis-(2-methyl-4-phenylindenyl) zirconium di-C₁-C₄ alkyl, racemic-(dimethylsilanediyl)-bis-(2-methyl-4-phenylindenyl) zirconium di-C₁-C₄ alkoxide, or any combination thereof and the like.

It is also possible to use the following titanium-based constrained geometry catalysts, [n-(1,1-dimethylethyl)-1,1-dimethyl-1-[(1,2,3,4,5-)-1,5,6,7-tetrahydro-s-indacen -yl]silanaminato(2-)-n]titanium dimethyl; (1-indenyl)(tert-butylamido)dimethyl-silane titanium dimethyl; ((3-tert-butyl)(1,2,3,4,5-) -indenyl)(tert-butylamido) dimethylsilane titanium dimethyl; and ((3-iso-propyl)(1,2,3,4,5-)-indenyl)(tert-butylamido)dimethylsilane titanium dimethyl, or any combination thereof and the like.

Further preparative methods for the interpolymers used in the present invention have been described in the literature. Longo and Grassi (Makromol. Chem. Volume 191, pages 2387 to 2396 [1990]) and D'Anniello et al. (Journal of Applied Polymer Science, Volume 58, pages 1701-1706 [1995]) reported the use of a catalytic system based on methylalurnoxane (MAO) and cyclopentadienyl-titanium trichlorlde (CpTiCl₃) to prepare an ethylene-styrene copolymer. Xu and Lin (Polymer Preprints Am. Chem. Soc., Div. Polym. Chem.), Volume 35, pages 686,687 [1994]) have reported copolymerization using a MgCl₂/TiCl₄/NdCl₃/Al(iBu)₃ catalyst to give random copolymers of styrene and propylene. Lu et al (Journal of Applied Polymer Science, Volume 53, pages 1453 to 1460 [1994]) have described the copolymerization of ethylene and styrene using a TiCl/4/NdCl₃/MgCl₂/al(Et)₃ catalyst. Sernetz and Mulhaupt, (Macromol. Chem. Phys., V. 197, pp. 1071-1083, 1997) have described the influence of polymerization conditions on the copolymerization of styrene with ethylene using Me₂Si(Me₄Cp)(n-tert-butyl)TiCl₂/Methylaluminoxane Ziegler-Natta catalysts. Copolymers of ethylene and styrene produced by bridged metallocene catalysts have been described by Arai, Toshiaki and Suzuki (Polymer Preprints Am. Chem. Soc. Div. Polym. Chem.), Volume 38, pages 349, 350 [1997]) and in U.S. Pat. No. 5,652,315, issued to Mitsui Toatsu Chemicals, Inc. The manufacture of α-olefin/vinyl aromatic monomer interpolymers such as propylene/styrene and butene/styrene are described in U.S. Pat. No. 5,244,996, issued to Mitsui Petrochemical Industries Ltd. or U.S. Pat. No. 5,652,315 also issued to Mitsui Petrochemical Industries Ltd. or as disclosed in DE 197 11339 A1 to Denki Kagaku Kogyo KK. All of the above disclosures of methods for preparing the interpolymer component are incorporated herein by reference. Also, although of high isotacticity and therefore not “substantially random”, the random copolymers of ethylene and styrene as disclosed in Polymer Preprints, Vol. 39, no. 1, March 1998 by Toru Aria et al. (the disclosure of which is incorporated herein by reference) can also be employed as the ethylene polymer of the present invention.

While preparing the substantially random interpolymer, an amount of atactic vinyl aromatic homopolymer may be formed due to homopolymerization of the vinyl aromatic monomer at elevated temperatures. The presence of vinyl aromatic homopolymer is in general not detrimental for the purposes of the present invention and can be tolerated. The vinyl aromatic homopolymer may be separated from the interpolymer, if desired, by extraction techniques such as selective precipitation from solution with a non-solvent for either the interpolymer or the vinyl aromatic homopolymer. Nevertheless, for the purpose of the present invention, it is preferred that no more than 20 weight percent, preferably less than 10 weight percent (based on the total weight of the interpolymers) of atactic vinyl aromatic homopolymer be is present.

The polypropylene and ethylene polymers may be produced via a continuous (as opposed to a batch) controlled polymerization process using at least one reactor for each polymer. But the inventive polymer blend composition itself (or a blend comprising or constituting the polypropylene polymer and/or a separate blend comprising or constituting the ethylene polymer) can also be produced using multiple reactors (e.g., using a multiple reactor configuration as described in U.S. Pat. No. 3,914,342 (Mitchell), incorporated herein by reference), with the polypropylene polymer being manufactured in one reactor and the ethylene polymer being manufactured in at least one other reactor. The multiple reactors can be operated in series or in parallei.

In general, the continuous polymerization useful for making the ethylene polymers used in the present invention may be accomplished at conditions well known in the prior art for Ziegler-Nafta or Kaminsky-Sinn type polymerization reactions, that is, temperatures from 0 to 250° C. and pressures from atmospheric to 1000 atmospheres (100 MPa).

The compounding disclosed herein can be accomplished by any convenient method, including dry blending the individual components and subsequently melt mixing or by pre-melt mixing in a separate extruder (e.g., a Banbury mixer, a Haake mixer, a Brabender internal mixer, or a twin (or single) screw extruder, including pelletization extrusion). Preferably, for efficiency, compounding to provide the non-sealant layer is accomplished by tumble-blending the propylene-rich polypropylene polymer and the ethylene-rich ethylene interpolymer together and subsequently directly feeding the dry blend into a coextrusion blown film unit.

Another suitable technique for making the non-sealant layer blend is in-situ polymerization such as provided in pending U.S. Ser. No. 08/010,958, entitled “Ethylene Interpolymerizations”, which was filed Jan. 29, 1993 in the names of Brian W. S. Kolthammer and Robert S. Cardwell, the disclosure of which is incorporated herein in its entirety by reference. U.S. Ser. No. 08/010,958 describes, inter alia, interpolymerizations of ethylene and C₃-C₂₀ alpha-olefins using a homogeneous catalyst in at least one reactor and a heterogeneous catalyst in at least one other reactor and this method can be adapted to employ a polypropylene polymerization reactor as a substitute for the heterogeneous catalyzed ethylene polymerization reactor or as an additional reactor. That is, the in situ polymerization can comprise at least three reactors where at least two reactors provide the ethylene polymer (as a polymer blend composition) and at least one reactor provide the reactor grade polypropylene polymer. For in situ polymerizations, the multiple reactors can be operated sequentially or in parallel. But preferably, when in situ polymerization is used it is only employed to provide suitable ethylene polymers (or ethylene polymer blend compositions) and not the inventive composition itself.

Additives, such as antioxidants (e.g., hindered phenolics, such as IRGANOX™ 1010 or IRGANOX™ 1076 supplied by Ciba Geigy), phosphites (e.g., IRGAFOS™ 168 also supplied by Ciba Geigy), cling additives (e.g., PIB), SANDOSTAB PEPQ™ (supplied by Sandoz), pigments, colorants, fillers, anti-stats, processing aids, and the like may also be included in the polymer mixture of the present invention or in films formed from the same. Although generally not required, films, coatings and moldings formed from the polymer mixture of the present invention may also contain additives to enhance antiblocking, mold release and coefficient of friction characteristics including, but not limited to, untreated and treated silicon dioxide, talc, calcium carbonate, and clay, as well as primary, secondary and substituted fatty acid amides, release agents, silicone coatings, etc. Still other additives, such as quaternary ammonium compounds alone or in combination with ethylene-acrylic acid (EAA) copolymers or other functional polymers, may also be added to enhance the antistatic characteristics of films, coatings and moldings formed from the polymer mixture of the invention and permit the use of these polymer mixtures in, for example, the heavy-duty packaging of electronically sensitive goods.

The polypropylene layer and especially the sealant layer may further include recycled and scrap materials and diluent polymers, to the extent that the improved sealant properties are maintained. Exemplary diluent materials include, for example, elastomers, rubbers and anhydride modified polyethylenes (e.g., polybutylene and maleic anhydride grafted LLDPE and HDPE) as well as with high pressure polyethylenes such as, for example, low density polyethylene (LDPE), ethylene/acrylic acid (EAA) interpolymers, ethylene/vinyl acetate (EVA) interpolymers and ethylenelmethacrylate (EMA) interpolymers, and combinations thereof.

In preferred embodiments where LDPE is used as a blend component as to the ethylene polymer in either the sealant layer or the polypropylene layer or both, the LDPE is characterized as having a high strength. In these embodiments, the melt strength of the LDPE is preferentially greater than 10 cN as determined using a Gottfert Rheotens unit at 190° C., more preferably from about 13 to 40 cN, and most preferably 15 to 25 cN. Further, in certain preferred embodiments, where the ethylene-rich ethylene interpolymer and the second ethylene polymer are blended with a LDPE, the melt strength of these blends is greater than 5 cN as determined using Gottfert Rheotens unit at 190° C., preferably from about 15 to 70 cN, and most preferably 15 to 50 cN.

The multilayer film may find utility in a variety of applications. Preferred applications, which make use of the film's improved sealing properties and good stiffness, include, pouches for packaging flowable material (especially pouches made using vertical form-fill-seal equipment), heavy-duty shipping sacks and overwrap film. Other applications include, but are not limited to, multilayer packaging structures where the structure is oriented (preferably biaxially oriented) for shrink film and barrier shrink applications, cook-in packaged foods, liners, gaskets and lidding stock.

The multilayer film structure comprises two, three or more layers. In a preferred embodiment, the multilayer film structure is a three layer structure with the polypropylene layer interposed between the sealant layer and an outer layer. The outer may comprise an ethylene polymer and the this ethylene polymer may be the same as either ethylene-rich ethylene interpolymer or the second ethylene interpolymer.

The multilayer film structure of the invention may any thickness required in its intended use. Preferably, however, the total thickness is in the range of from about 0.25 mil to about 15 mils, more preferably in the range of from about 0.5 mil to about 4 mils. The sealant layer (and an outer layer if present such as in a three layer structure) may preferably constitute from about 2 to about 50 percent of the total thickness, more preferably from about 10 to 45 percent.

Although not required, adhesion promoting tie layers (such as PRIMACOR™ ethylene-acrylic acid (EAA) copolymers available from The Dow Chemical Company, and/or ethylene-vinyl acetate (EVA) copolymers, as well as additional structural layers (such as AFFINITY™ polyolefin plastomers, available from The Dow Chemical Company, ENGAGE™ polyolefin elastomers, available from Dupont Dow Elastomers, DOWLEX™ LLDPE, available from The Dow Chemical Company, ATTANE™ ULDPE, available from The Dow Chemical Company, or blends of any of these polymers with each other or with another polymer, such as EVA) may be optionally employed.

Other layers including but are not limited to barrier layers, and/or tie layers, and/or structural layers may be added to the multilayer film structure by coextrusion or by lamination techniques. Various materials can be used for these layers, with some of them being used as more than one layer in the film structure. Representative materials include: foil, nylon, ethylene/vinyl alcohol (EVOH) copolymers, polyvinylidene chloride (PVDC), polyethylene terepthalate (PET), oriented polypropylene (OPP) (more especially, biaxially oriented polypropylene), ethylene/vinyl acetate (EVA) copolymers, ethylene/acrylic acid (EM) copolymers, ethylene/methacrylic acid (EMAA) copolymers, ULDPE, LLDPE, HDPE, MDPE, LMDPE, LDPE, ionomers, graft-modified polymers (e.g., maleic anhydride grafted polyethylene), and paper. Generally, the multilayer structure of the present invention may comprise from 2 to about 7 layers.

Cook-in packaged foods are foods which are prepackaged and then cooked. The packaged and cooked foods go directly to the consumer, institution, or retailer for consumption or sale. A package for cook-in must be structurally capable of withstanding exposure to cook-in time and temperature conditions while containing a food product. Cook-in packaged foods are typically employed for the packaging of ham, turkey, vegetables, processed meats, etc.

Vertical form/fill/seal packages are typically utilized for the packaging of flowable materials, such as milk, wine, powders, etc. In a vertical form/fill/seal (VFFS) packaging process, a sheet of the plastic film structure is fed into a VFFS machine where the sheet is formed into a continuous tube by sealing the longitudinal edges of the film together by lapping the plastic film and sealing the film using an inside/outside seal or by fin sealing the plastic film using an inside/inside seal. Next, a sealing bar seals the tube transversely at one end to form the bottom of a pouch. The flowable material is then added to the formed pouch. The sealing bar then seals the top end of the pouch and either burns through the plastic film or a cutting device cuts the film, thus separating the formed completed pouch from the tube. The process of making a pouch with a VFFS machine is generally described in U.S. Pat. Nos. 4,503,102 and 4,521,437, the disclosures of which are incorporated herein by reference. Because of the improved sealing properties and good stiffness, the inventive multilayer film structure is well-suited for cook-in and vertical form/fill/seal packaging applications.

Multilayer film manufacturing techniques are described in The Encyclopedia of Chemical Technology, Kirk-Othmer, Third Edition, John Wiley & Sons, New York, 1981, Vol. 16, pp. 416-417 and Vol. 18, pp. 191-192; Packaging Foods With Plastics, by Wilmer A. Jenkins and James P. Harrington (1991), pp. 19-27; “Coextrusion Basics” by Thomas I. Butler, Film Extrusion Manual: Process, Materials, Properties pp. 31-80 (published by TAPPI Press (1992)); “Coextrusion For Barrier Packaging,” by W. J. Schrenk and C. R. Finch, Society of Plastics Engineers RETEC Proceedings, Jun. 15-17, 1981, pp. 211-229; K. R. Osborn and W. A. Jenkins; and Plastic Films, Technology and Packaging Applications (Technomic Publishing Co., Inc. (1992)), the disclosures of which are incorporated herein by reference.

After fabrication, the multilayer film of the present invention may be oriented (off-line or in a continuous operation) using methods and procedures well known in the art. Biaxial orientation processes such as tenter frames, “trapped bubble” and “double bubble” processes can be used to orient the film. Suitable techniques are described in U.S. Pat. No. 3,456,044 (Pahike); U.S. Pat. No. 4,865,902 (Golike et al.); U.S. Pat. No. 4,352,849 (Mueller); U.S. Pat. No. 4,820,557 (Warren); U.S. Pat. No. 4,927,708 (Herran et al.); U.S. Pat. No. 4,963,419 (Lustig et al.); and U.S. Pat. No. 4,952,451 (Mueller), the disclosures of each of which are incorporated herein by reference.

### EXAMPLES

In an evaluation to develop an improved multilayer film structure, a three layer film structure was made and compared to commercial film structures. The three layer film structure was made on a blown film coextrusion line where Layer “A” (the sealant layer comprising a blend of 20 weight percent LDPE 503 with 80 weight percent DOWLEX LLDPE 2070D) was extruded using a 2.5 inch (6.4 cm) diameter Egan extruder equipped with a single flighted screw having two Egan-type mixing sections; layer “B” (the core layer comprising a tumble blend of 20 weight percent DOWLEX LLDPE 2045 with 80 weight percent SR 256M Polypropylene) was extruded using a 2.5 inch (6.4) diameter Egan extruder equipped with a single flighted screw having two Maddock type mixing sections; and layer “C” (the outer layer comprising a blend of 20 weight percent LDPE 503 with 80 weight percent DOWLEX LLDPE 2070D) was extruded using a 2 inch (5.1 cm) diameter Egan extruder equipped with a single flighted screw having one Maddock type mixing section. The total configuration was set for a target output of about 150 pounds/hour. The weight output ratios of the extruders were targeted at 15%/70%/15% for the A/B/A extruders. Polymer melt temperatures are targeted at 415 F./450 F./425 F. (239 C./261 C/246 C) for layers A/B/A, respectively. A 70 mil die gap was used for the eight inch (20.3 cm) multi-channel annular die. Films were air blown to a 2.5:1 blow-up ratio (BUR) and air-quenched to produce the three layer A/B/A multilayer film. Frost line height was about 20 inches (51 cm) and the film (Inventive Example 1) exhibited excellent bubble stability at the targeted output rate.

Various other films were prepared using the same procedure as described for Example 1.

Table 1 provides the description of the polymers used to prepare Example 1 as well as the other films. The physical properties of Example 1, various commercial films and the other films were determined using standardized test method. Gloss, haze, and clarity are tested in accordance with ASTM D-1746, ASTM D-1003, and ASTM D-2457, respectively. Puncture resistance was tested in accordance with ASTM D3763. Dart Impact was determined in accordance with ASTM D 1709, Method A. Elmendorf tear resistance was determined in accordance with ASTM D1922. Tensile properties and the secant modulus were determined in accordance with ASTM D882.

The hot tack strength of the films was measured using the “JB Instrument Hot Tack Test Method,” which measures the force required to separate a heat seal before the seal has had a chance to fully cool (crystallize). This test simulates the filling of material into a pouch or bag before the seal has had a chance to completely cool.

The “JB Instrument Hot Tack Test Method” is a test method using a JB Instrument Hot Tack Tester according to the following conditions:

| | | |
|---|---|---|
| Specimen Width: | 25.4 | mm |
| Sealing Time: | 0.5 | seconds |
| Sealing Pressure: | 0.27 | N/mm/mm |
| Delay Time: | 0.2 | seconds |
| Peel Speed: | 250 | mm/seconds |
| Number of Samples per Temperature | 5 | |
| Temperature Increments: | 5° | C. |

The heat seal strength of sample films was measured using the “JB Instrument Heat Seal Strength Test Method,” which is designed to measure the force required to separate a seal after the material has completely cooled to 23° C. The film samples were exposed to a relative humidity of 50 percent and a temperature of 23° C. for a minimum of 24 hours prior to testing.

TABLE 1

| | | Density | I₂ Melt index | |
|---|---|---|---|---|
| Ethylene Polymers | Description | g/cc | at 190° C.(g/10 min.) | Supplier |
| AFFINITY PL1880 | Polyolefin Plastomer made using CGCT | 0.902 | 1.0 | The Dow Chemical Company |
| XU59900.20 | Enhanced LLDPE made using CGCT | 0.940 | 0.8 | The Dow Chemical Company |
| ELITE 5101 | Enhanced LLDPE made using CGCT | 0.921 | 0.9 | The Dow Chemical Company |
| ELITE 5400 | Enhanced LLDPE made using CGCT | 0.916 | 1.0 | The Dow Chemical Company |
| Exceed 350D60 | mLLDPE | 0.917 | 1.0 | Exxon Chemical Company |
| XUS61528.20 | Linear Low Density Polyethylene | 0.920 | 0.5 | The Dow Chemical Company |
| DOWLEX 2037 | Linear Low Density Polyethylene | 0.935 | 2.5 | The Dow Chemical Company |
| DOWLEX 2045 | Linear Low Density Polyethylene | 0.920 | 1.0 | The Dow Chemical Company |
| DOWLEX 2038 | Linear Low Density Polyethylene | 0.935 | 1.0 | The Dow Chemical Company |
| LDPE 420R | Low Density Polyethylene | 0.930 | 3.2 | The Dow Chemical Company |
| LDPE 503 | Low Density Polyethylene | 0.923 | 1.9 | The Dow Chemical Company |
| | | | Melt flow rate | |
| Polypropylene | Description | Density | at 230° C. (g/10 min.) | Supplier |
| INSPIRE DC108 | Impact Copolymer Polypropylene | 0.9 | 0.8 | The Dow Chemical Company |
| INSPIRE C105-02 | Impact Copolymer Polypropylene | 0.9 | 2 | The Dow Chemical Company |
| PROFAX SR256M | Random Copolymer Polypropylene | 0.9 | 2 | Montell |
| PROFAX H700-12 | Homopolymer Polypropylene | 0.9 | 12 | Montell |
| EPQ30RF | Impact Copolymer Polypropylene | 0.9 | 0.8 | Montell |

mLLDPE denotes metallocene linear low density ethylene polymer
CGCT denotes constrained geometry catalyst technology

The “JB Instrument Heat Seal Strength Test Method” uses a JB Instrument Hot Tack Tester, wherein the heat seal portion of the tester is used, according to the following conditions:

| | | |
|---|---|---|
| Specimen Width: | 25.4 | mm |
| Sealing Time: | 0.5 | seconds |
| Sealing Pressure: | 0.27 | N/mm/mm |
| Number of Samples/Temperature | 5 | |
| Temperature Increments: | 5° | C. |

The seal strength of the film samples was determined using an Instron Tensile Tester Model #1122 according to the following test conditions:

| | | |
|---|---|---|
| Direction of Pull: | 90° | C. to seal |
| Crosshead Speed: | 500 | mm/minute |
| Full Scale Load: | 5 | kg |
| Number of Samples/Threshold: | 1 | percent of FSL |
| Break Criterion: | 80 | percent |
| Gauge Length: | 2.0 | inches |
| | (50.8 | millimeters) |
| Sample Width: | 1.0 | inch |
| | (25.4 | millimeters) |

The films shown in Table 2 were taken from paper towel roll packs or toilet tissue packs purchased from local grocery stores. These show a large variation in physical properties. For example, the haze properties of the comparative samples ranged from a value of 8.6 to 26.5 percent. Conversely, Example 1 exhibited a dramatically improved haze value of 4.5 percent. Low haze is a desirable attribute by the consumer so that the contents of the package can easily be seen.

High gloss results in a shiny surface, again, a highly desirable feature for the looks of the package. Example 1 was found to have a much higher surface gloss than any of the comparative films. Also, the clarity of Example 1 was much higher than any of the comparative films.

Modulus is an indicator of the stiffness of a film. High speed packaging lines require films to be high in stiffness, this is the most common limiting factor to high packaging line speeds and is referenced in Richard Halle's report “Downgauge Paper Overwrap Films Using mLLDPE Blends”. Furthermore, low stiffness films result in printing problems with respect to registration and poor roll conformity.

Table 2 shows that the downgauged Example 1 has much higher secant modulus than any of commercial comparative films.

Ideally, for application such as soft goods overwrap, the packaging film should have high puncture resistance to prevent the package from failing before its intended use; however, once the film has been punctured it should be easily opened by tearing. This is also referenced in Richard Halle's report “Downgauge Paper Overwrap Films Using mLLDPE Blends”, the disclosure of which is incorporated by reference. Table 2 shows that all of the comparative films had low puncture resistance and high tear resistance relative to Example 1, thus Example 1 is more ideal for overwrap packaging than some commercial films.

Fast packaging lines speeds also require that the seal remain intact during the initial seconds after sealing. The hot tack test simulates the stresses that are placed on the hot molten seal before it is cooled. High hot tack strength is required for fast packaging speeds. Example 1 had 2.5 times the hot tack strength of Comparative 4.

Physical properties (including hot tack and heat seal strength performance) of the various other three-layer (A/B/A) films are reported in Tables 3 and 4 below.

TABLE 2

| | Comp. | Comp. | Comp. | Comp. | Comp. | Comp. | Comp. | Comp. | Comp. | |
|---|---|---|---|---|---|---|---|---|---|---|
| | Example 1 | Example 2 | Example 3 | Example 4 | Example 5 | Example 6 | Example 7 | Example 8 | Example 9 | Example 1 |
| Films | Bounty | Branwny | Sparkle | 125 | 4 Pack | 6 Pack | Charmin | Angel Soft | Coronet | A/B/A |
| | Paper | Paper | Paper | Blancas | Papers | Paper | Toilet | Toilet | Toilet | coex |
| | Towels | Towels | Towels | Napkins | Towels | Towels | Tissue | Tissue | Tissue | |
| Avg Thickness, mils | 2.0 | 1.7 | 1.6 | 1.7 | 1.8 | 1.9 | 1.2 | 1.5 | 1.6 | 1.0 |
| Avg Haze Value, % | 23.0 | 13.0 | 11.2 | 8.6 | 13.1 | 9.2 | 26.5 | 16.5 | 12.6 | 4.5 |
| Avg Gloss 45 Deg, % | 41.0 | 68.2 | 64.9 | 66 | 65.2 | 71.8 | | | | 78 |
| Avg Clarity, transm. | | | | 91.5 | 91.0 | 93.7 | | | | 96 |
| MD - Avg 1% SECANT, psi | 38,801 | 59,554 | 62,511 | 36,021 | 47,960 | 48,910 | | | | 84,308 |
| CD - Avg 1% SECANT, psi | 47,280 | 75,372 | 53,092 | 35,113 | 56,810 | 56,825 | | | | 89,501 |
| MD - Avg 2% SECANT, psi | 32,512 | 50,284 | 51,758 | 30,542 | 40,413 | 40,904 | 60,670 | 25,423 | 52472 | 66,238 |
| CD - Avg 2% SECANT, psi | 39,118 | 60,370 | 45,011 | 29,183 | 47,120 | 47,366 | 72,900 | 28,757 | 47217 | 69,931 |
| Avg Elmendorf Type B MD, | 314 | 37 | | 429 | 638 | 763 | 437 | 137 | 63 | 18 |
| gms | | | | | | | | | | |
| Avg Elmendorf Type B CD, | 355 | 936 | | 397 | 1,157 | 790 | 472 | 506 | 175 | 720 |
| gms | | | | | | | | | | |
| Dart impact, gms | 76 | 32 | | | | | 46 | 113 | 54 | 76 |
| Avg PUNCTURE, ft-lb/in3 | 17 | 23 | | | | | 11 | 25 | 8 | 109 |
| Maximum Heat Seal Strength | | | | 2.9 | 2.1 | 1.0 | | | | |
| (lb/in) | | | | | | | | | | |
| Maximum Hot Tack Strength | | | | 1.7 | 1.1 | 1.6 | | | | 5.02 |
| (N/25 mm) | | | | | | | | | | |

*No polypropylene was detected in any of the commercial samples via NMR or DSC
A (20%) = 20% LDPE 503 80% DOWLEX 2070D
B (60%) = 20% Dowlex 2045 80% PP SR 256M

TABLE 3

| | Comp. | | Comp. | | Comp. | | Comp. | |
|---|---|---|---|---|---|---|---|---|
| Structure | Example 10 | Example 2 | Example 11 | Example 3 | Example 12 | Example 4 | Example 13 | Example 5 |
| A Layer (20%) | | | | | | | | |
| LDPE 503 | 20% | 20% | 20% | 20% | | | | |
| DOWLEX 2070D | 80% | 80% | 80% | 80% | | | | |
| ELITE 5101 | | | | | 100% | 100% | 100% | 100% |
| Exceed 350d60 | | | | | | | | |
| B Layer (core) (60%) | | | | | | | | |
| DOWLEX 2038 | 100% | | 100% | | 100% | | 100% | |
| SR 256M | | 80% | | 80% | | 80% | | 80% |
| DOWLEX 2045 | | 20% | | 20% | | 20% | | 20% |
| Physical Properties | | | | | | | | |
| Avg Thickness, mils | 1.0 | 1.0 | 1.6 | 1.8 | 1.0 | 1.0 | 1.7 | 1.8 |
| Avg Haze Value, % | 5.7 | 4.5 | 7.5 | 6.3 | 8.8 | 11.0 | 5.9 | 11.6 |
| Avg Gloss 45 Deg, % | 76.0 | 78.7 | 74.0 | 73.0 | 71.0 | 56.4 | 77.5 | 60.4 |
| Avg Clarity, transm. | 95.0 | 96.7 | 95.4 | 96.0 | 94.0 | 92.6 | 94.0 | 90.3 |
| MD - Avg 1% SECANT, psi | 60,318 | 84,308 | 56,167 | 82,402 | 57,392 | 74,797 | 51,892 | 73,991 |
| CD - Avg 1% SECANT, psi | 73,763 | 89,501 | 71,774 | 79,183 | 73,344 | 84,525 | 76,778 | 73,736 |
| MD - Avg 2% SECANT, psi | 52,963 | 66,238 | 48,343 | 66,049 | 48,884 | 58,092 | 60,236 | 59,989 |
| CD - Avg 2% SECANT, psi | 63,354 | 69,931 | 60,791 | 65,646 | 61,663 | 65,404 | 64,815 | 60,037 |
| MD - Avg ULTIMATE, psi | 5,808 | 8,040 | 5,571 | 7,690 | 5,766 | 9,179 | 6,238 | 7,912 |
| CD - Avg ULTIMATE, psi | 4,869 | 6,106 | 5,195 | 6,714 | 4,922 | 5,535 | 4,788 | 6,509 |
| MD - Avg YIELD STRENGTH, | 2,196 | 3,028 | 2,059 | 2,872 | 2,043 | 2,867 | 2,078 | 2,696 |
| psi | | | | | | | | |
| CD - Avg YIELD STRENGTH, | 2,755 | 2,755 | 2,346 | 2,702 | 2,303 | 2,602 | 2,284 | 2,638 |
| psi | | | | | | | | |
| MD - Avg ELONGATION, % | 548 | 549 | 636 | 653 | 614 | 506 | 541 | 572 |
| CD - Avg ELONGATION, % | 704 | 742 | 737 | 795 | 627 | 609 | 623 | 663 |
| Avg Elmendorf Type B MD, | 77 | 18 | 190 | 50 | 326 | 67 | 134 | 165 |
| gms | | | | | | | | |
| Avg Elmendorf Type B CD, | 737 | 720 | 907 | 805 | 868 | 512 | 563 | 570 |
| gms | | | | | | | | |
| Dart impact, gms | 72 | 76 | 190 | 134 | 246 | 156 | 150 | 310 |
| Avg PUNCTURE, ft-lb/in3 | 86 | 109 | 93 | 111 | 69 | 114 | 100 | 122 |
| Heat Seal Strength, lb/in | | | | | | | | |
| Temperature, ° C. | | | | | | | | |
| 80 | | | | 0.03 | | 0.79 | | |
| 90 | | 0.04 | | 0.03 | | 0.05 | | 0.06 |
| 100 | 0.16 | 0.10 | 0.08 | 0.09 | 0.06 | 1.00 | 0.04 | 2.30 |
| 110 | 2.43 | 2.93 | 3.64 | 4.65 | 2.25 | 2.75 | 1.31 | 4.19 |
| 120 | 3.26 | 2.48 | 4.29 | 3.45 | 2.62 | 3.26 | 4.01 | 4.85 |
| 130 | 2.81 | 2.61 | 4.41 | 3.44 | 2.30 | 2.61 | 4.00 | 4.95 |
| 140 | 3.49 | 2.65 | 4.62 | 3.31 | 1.67 | 4.61 | 3.91 | 6.39 |
| 150 | 3.43 | 2.68 | 4.51 | 2.48 | 1.60 | 3.99 | 3.25 | 4.05 |
| Hot Tack Strength N/25 mm | | | | | | | | |
| Temperature, ° C. | | | | | | | | |
| 90 | 0.26 | 0.16 | 0.20 | 0.13 | 0.19 | 0.52 | 0.13 | 0.82 |
| 100 | 1.38 | 1.40 | 1.44 | 1.02 | 1.31 | 1.10 | 1.47 | 3.16 |
| 110 | 2.52 | 5.02 | 3.41 | 4.32 | 2.36 | 4.33 | 2.37 | 4.23 |
| 120 | 4.49 | 6.19 | 4.95 | 9.48 | 4.22 | 6.05 | 4.00 | 7.46 |
| 130 | 3.17 | 6.46 | 2.85 | 7.69 | 2.86 | 6.47 | 3.39 | 6.64 |
| 140 | 2.62 | 5.28 | 3.74 | 5.32 | 2.31 | 3.76 | 3.28 | 3.57 |
| 150 | 2.23 | 4.16 | 1.89 | 3.61 | 2.09 | 2.76 | 2.92 | 0.93 |
| Maximum Hot Tack Strength, | 4.49 | 6.46 | 4.95 | 9.48 | 4.22 | 6.47 | 4.00 | 7.46 |
| N/25 mm | | | | | | | | |

TABLE 4

| | Comp. | Comp. | | | | | | |
|---|---|---|---|---|---|---|---|---|
| Structure | Ex. 14 | Ex. 15 | Ex. 2 | Ex. 3 | Ex. 4 | Ex. 5 | Ex. 6 | Ex. 7 |
| A Layer (20%) | | | | | | | | |
| LDPE 503 | 100% | 100% | 20% | 20% | | | | |
| DOWLEX 2070D | | | 80% | 80% | | | | |
| ELITE 5101 | | | | | 100% | 100% | | |
| Exceed 350d60 | | | | | | | 100% | 100% |
| B Layer (core) (60%) | | | | | | | | |
| SR 256M | 80% | 80% | 80% | 80% | 80% | 80% | 80% | 80% |
| DOWLEX 2045 | 20% | 20% | 20% | 20% | 20% | 20% | 20% | 20% |
| Avg Thickness, mils | 1.0 | 1.9 | 1.0 | 1.8 | 1.0 | 1.8 | 0.9 | 1.8 |
| Avg Haze Value, % | 7.0 | 7.6 | 4.5 | 6.3 | 11.0 | 11.6 | 10.0 | 12.9 |
| Avg Gloss 45 Deg, % | 69.4 | 65.6 | 78.7 | 73.0 | 56.4 | 60.4 | 63.8 | 57.5 |
| Avg Clarity, transm. | 92.1 | 90.7 | 96.7 | 96.0 | 92.6 | 90.3 | 93.8 | 92.8 |
| MD - Avg 1% Secant, psi | 78,405 | 73,964 | 84,308 | 82,402 | 74,797 | 73,991 | 79,292 | 74,377 |
| CD - Avg 1% Secant, psi | 84,204 | 84,767 | 89,501 | 79,183 | 84,525 | 73,736 | 80,680 | 78,281 |
| MD - Avg 2% Secant, psi | 62,972 | 60,867 | 66,238 | 66,049 | 58,092 | 59,989 | 62,015 | 61,483 |
| CD - Avg 2% Secant, psi | 65,122 | 68,340 | 69,931 | 65,646 | 65,404 | 60,037 | 62,452 | 63,625 |
| MD - Avg Ultimate, psi | 6,089 | 6,260 | 8,040 | 7,690 | 9,179 | 7,912 | 9,171 | 8,739 |
| CD - Avg Ultimate, psi | 5,230 | 5,485 | 6,106 | 6,714 | 5,535 | 6,509 | 7,132 | 7,449 |
| MD - Avg Yield Strength, | 2,950 | 2,907 | 3,028 | 2,872 | 2,867 | 2,696 | 3,147 | 2,858 |
| psi | | | | | | | | |
| CD - Avg Yield Strength, | 2,621 | 2,807 | 2,755 | 2,702 | 2,602 | 2,638 | 2,736 | 2,727 |
| psi | | | | | | | | |
| MD - Avg Elong., % | 452 | 634 | 549 | 653 | 506 | 572 | 555 | 638 |
| CD - Avg Elong., % | 742 | 769 | 742 | 795 | 609 | 663 | 625 | 699 |
| Avg Elmendorf Type B | 11 | 27 | 18 | 50 | 67 | 165 | 127 | 175 |
| MD, gms | | | | | | | | |
| Avg Elmendorf Type B | 575 | 639 | 720 | 805 | 512 | 570 | 451 | 551 |
| CD, gms | | | | | | | | |
| Dart impact, gms | 45 | 210 | 76 | 134 | 156 | 310 | 152 | 310 |
| Avg Puncture, ft-lb/in3 | 74 | 85 | 109 | 111 | 114 | 122 | 148 | 136 |
| Avg Kinetic COF (F-M) | 0.42 | 0.42 | 0.48 | 0.35 | 0.37 | 0.36 | 0.39 | 0.29 |
| Avg Static COF (F-M) | 0.53 | 0.52 | 0.54 | 0.44 | 0.49 | 0.46 | 0.50 | 0.35 |
| Heat Seal Strength, lb/in | | | | | | | | |
| Temperature, C. | | | | | | | | |
| 80 | 0.24 | | | 0.03 | 0.79 | | 0.02 | |
| 90 | 0.02 | 0.02 | 0.04 | 0.03 | 0.05 | 0.06 | 0.03 | 0.03 |
| 100 | 0.07 | 0.05 | 0.10 | 0.09 | 1.00 | 2.30 | 0.12 | 0.12 |
| 110 | 1.11 | 1.49 | 2.93 | 4.65 | 2.75 | 4.19 | 2.81 | 4.53 |
| 120 | 0.98 | 1.42 | 2.48 | 3.45 | 3.26 | 4.85 | 3.09 | 5.56 |
| 130 | 1.03 | 1.38 | 2.61 | 3.44 | 2.61 | 4.95 | 3.43 | 5.26 |
| 140 | 1.35 | 1.66 | 2.65 | 3.31 | 4.61 | 6.39 | 3.65 | 5.98 |
| 150 | 1.07 | 1.65 | 2.68 | 2.48 | 3.99 | 4.05 | 3.55 | 6.63 |
| Hot Tack Strength N/25 mm | | | | | | | | |
| Temperature, C. | | | | | | | | |
| 80 | 0.13 | 0.12 | 0.13 | 0.13 | 0.15 | 0.12 | 0.14 | 0.12 |
| 90 | 0.12 | 0.14 | 0.16 | 0.13 | 0.52 | 0.82 | 0.12 | 0.11 |
| 100 | 0.33 | 0.27 | 1.40 | 1.02 | 1.10 | 3.16 | 0.24 | 0.12 |
| 110 | 2.54 | 2.28 | 5.02 | 4.32 | 4.33 | 4.23 | 5.05 | 4.99 |
| 120 | 1.93 | 2.63 | 6.19 | 9.48 | 6.05 | 7.46 | 6.16 | 10.34 |
| 130 | 3.47 | 2.17 | 6.46 | 7.69 | 6.47 | 6.64 | 5.98 | 7.10 |
| 140 | 2.23 | 1.52 | 5.28 | 5.32 | 3.76 | 3.57 | 5.23 | 5.40 |
| 150 | 0.64 | 0.54 | 4.16 | 3.61 | 2.76 | 0.93 | 2.34 | 3.27 |
| Maximum Hot Tack Strength, | 3.47 | 2.63 | 6.46 | 9.48 | 6.47 | 7.46 | 6.16 | 10.34 |
| N/25 mm | | | | | | | | |

*Outer layers were formulated with slip and antiblock additives. All films were made at a 2.5:1 BUR

The examples shown in Tables 2-4 demonstrate that the use of PP in the core of a blown coextruded film structure offers several important improvements or advantages over the use of polyethylene, including excellent optics, high modulus, high tensile properties, high puncture resistance, and high hot tack strength. All of these attributes are highly desirable for pouch, heavy-duty shipping sack and soft goods overwrap applications.

In another evaluation, two different three layer coextruded blown films were fabricated to further study the relationship between modulus and puncture. The films were coextruded as described above at a 2.5:1 blow-up ratio (BUR). Inventive Example 8 was prepared as follows and was determined to have al % MD secant modulus of 103,000 psi and a puncture resistance of 38.9 in-lb.:

A=AFFINITY PL1880

B=INSPIRE H308-02Z+5% AFFINITY PL 1880

C=ATTANE 4201

Comparative example 16 was prepared as follows and was determined to have a 1% MD secant modulus of 27,100 psi and a puncture resistance of 39.5 in-lb.:

A=AFFINITY PL 1880+20% LDPE 132

B=DOWLEX 2045 the 30% LDPE 132

C=ATTANE 4201+20% LDPE 132

These results show that the use of a propylene-rich polypropylene polymer can provide substantially increased modulus for a coextruded blown film without sacrificing puncture resistance properties. Thus, these results are very surprising because it has been traditionally accepted that as modulus increases toughness properties such as puncture resistance and dart impact variably decrease.

We claim:

1. A coextruded air-quenched multilayer blown film structure comprising:
(A) a non-sealant layer comprised of a propylene-rich polypropylene polymer blended with at least one ethylene-rich ethylene interpolymer, and
(B) a sealant layer comprised of at least one second ethylene interpolymer,
wherein the ethylene-rich ethylene interpolymer comprises ethylene interpolymerized with at least one other comonomer other than propylene and wherein the structure is characterized as having a maximum hot tack strength in the sealing temperature range of 80° C. to 150° of greater than 5.0 Newton/25 millimeter, when fabricated at a sealant layer thickness of 0.2 mil or greater and tested using a JB Instrument Hot Tack Tester set at a 0.5 second dwell, 0.2 second delay time, 40 psi seal bar pressure and 250 mm/second peel rate.

2. The film structure of claim 1 wherein the polypropylene polymer is a homopolymer.

3. The film structure of claim 1 wherein the polypropylene polymer is a random copolymer.

4. The film structure of claim 1 wherein the polypropylene polymer is an impact copolymer comprising ethylene.

5. The film structure of claim 1 wherein the ethylene-rich ethylene interpolymer is a heterogeneously branched ethylene interpolymer.

6. The film structure of claim 1 wherein the ethylene-rich ethylene interpolymer is a homogeneously branched ethylene interpolymer.

7. The film structure of claim 6 wherein the ethylene-rich ethylene interpolymer is a substantially linear ethylene interpolymer.

8. The film structure of claim 6 wherein the ethylene-rich ethylene interpolymer is a homogeneously branched linear ethylene interpolymer.

9. The film structure of claim 1 wherein the polypropylene polymer and the ethylene-rich ethylene interpolymer are blended in situ using multiple polymerization reactors.

10. The film structure of claim 1 wherein the ethylene-rich ethylene interpolymer is blended with another ethylene polymer.

11. The film structure of claim 10 wherein the ethylene-rich ethylene interpolymer is a heterogeneously branched linear ethylene interpolymer and the other ethylene polymer is a low density polyethylene homopolymer.

12. The film structure of claim 11 wherein the low density polyethylene homopolymer is characterized as having a melt strength greater than 10 cN as determined using a Gottfert Rheotens unit at 190° C.

13. The film structure of claim 1 wherein the structure is a three layer film structure with an non-sealant outer layer, a non-sealant core layer and the polypropylene layer (A) as the non-sealant core layer.

14. The film structure of claim 13 wherein the sealant layer and the non-sealant outer comprise the same polymer composition or combination.

15. The film structure of claim 1 wherein the sealant comprises a blend of a heterogeneously branched ethylene polymer and homogeneously branched ethylene interpolymer.

16. The film structure of claim 15 wherein the heterogeneously branched ethylene polymer is a copolymer of ethylene and a C₄-C₂₀ α-olefin.

17. The film structure of claim 1 wherein the ethylene-rich ethylene interpolymer is a homogeneously branched ethylene interpolymer and the second ethylene interpolymer is a heterogeneously branched linear ethylene interpolymer or a blend of a heterogeneously branched linear ethylene interpolymer and a low density polyethylene homopolymer.

18. The film structure of claim 17 wherein the heterogeneously branched linear ethylene interpolymer is a very low density polyethylene (VLDPE).

19. The film structure of claim 17 wherein the heterogeneously branched linear ethylene interpolymer is a linear low density polyethylene (LLDPE).

20. The film structure of claim 1 wherein the non-sealant polypropylene layer (A) is adjacent to the sealant layer (B).

21. The film structure of claim 1 wherein the sealant layer has a thickness in the range of about 0.15 to about 0.25 mil.

22. A process of making a multilayer blown film structure containing a polypropylene layer, comprising
a) obtaining a blown film coextrusion unit having at least two separate extruders which separately feed a multi-channel annular die,
b) blending a propylene-rich polypropylene polymer with at least one ethylene-rich ethylene interpolymer and feeding the blend to the first extruder of the coextrusion film unit,
b) feeding at least one second ethylene interpolymer to the second extruder of the coextrusion film unit,
c) simultaneously extruding the blend and the second ethylene interpolymer through the multi-channel annular die to form a molten tube, and
d) thereafter, using air to blow-up the tube into a bubble and quenching the bubble to form the multilayer blown film structure.

23. A pouch made from a coextruded air-quenched multilayer blown film structure which in tubular form has transversely heat sealed ends, the multilayer film structure comprising (A) a non-sealant layer comprised of a propylene-rich polypropylene polymer blended with at least one first ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure is characterized as having a maximum hot tack strength in the sealing temperature range of 80° C. to 150° of greater than 5.0 Newton/25 millimeter, when fabricated at a sealant layer thickness of 0.2 mil or greater and tested using a JB Instrument Hot Tack Tester set at a 0.5 second dwell, 0.2 second delay time, 40 psi seal bar pressure and 250 mm/second peel rate.

24. An overwrap film made from a coextruded air-quenched multilayer blown film structure comprising (A) a non-sealant layer comprised of a propylene-rich polypropylene polymer blended with at least one first ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure is characterized as having a maximum hot tack strength in the sealing temperature range of 80° C. to 150° of greater than 5.0 Newton/25 millimeter, when fabricated at a sealant layer thickness of 0.2 mil or greater and tested using a JB Instrument Hot Tack Tester set at a 0.5 second dwell, 0.2 second delay time, 40 psi seal bar pressure and 250 mm/second peel rate.

25. A heavy-duty shipping sack made from a coextruded air-quenched multilayer blown film structure comprising (A) a non-sealant layer comprised of a propylene-rich polypropylene polymer blended with at least one first ethylene-rich ethylene interpolymer and (B) a sealant layer comprised of at least one second ethylene interpolymer, wherein the ethylene-rich ethylene interpolymer comprises ethylene interpolymerized with at least one other comonomer other than propylene and the structure is characterized as having a maximum hot tack strength in the sealing temperature range of 80° C. to 150° of greater than 5.0 Newton/25 millimeter, when fabricated at a sealant layer thickness of 0.2 mil or greater and tested using a JB Instrument Hot Tack Tester set at a 0.5 second dwell, 0.2 second delay time, 40 psi seal bar pressure and 250 mm/second peel rate.

26. The pouch of claim 23 containing a flowable material.

27. The pouch of claim 27 wherein the pouch holds from about 5 mL to about 10,000 mL.

28. The pouch of claim 26 wherein the flowable material is milk.

29. The film structure of claim 1 wherein the film structure contains a slip agent, antiblock agent and, optionally, a processing aid.

30. The film structure of claim 1 wherein the film structure contains a pigment to render the film structure opaque.

31. The film structure of claim 1 wherein the film structure contains an ultraviolet light absorbing additive.
